(19) United States
(12) Patent Application Publication
(10) Pub. No.: US 2025/0272641 A1
(43) Pub. Date: Aug. 28, 2025

(54) PRIVACY PRESERVING SAFETY RISK DETECTION SYSTEM AND METHOD

(71) Applicants: Annamalai Muthiah, Ngunnawal, Australian Capital Territory (AU); Amogh Dhaliwal, Turner, Australian Capital Territory (AU)

(72) Inventors: Annamalai Muthiah, Ngunnawal, Australian Capital Territory (AU); Amogh Dhaliwal, Turner, Australian Capital Territory (AU)

(21) Appl. No.: 18/858,304

(22) PCT Filed: Apr. 20, 2023
(86) PCT No.: PCT/AU2023/050320

§ 371 Date: Oct. 19, 2024

(30) Foreign Application Priority Data
Apr. 20, 2022 (AU) 2022901045

(51) Int. Cl. G06Q 10/0635; G06F 21/62; G06T 11/60; G06V 20/52; G06V 40/10; H04N 5/272

(52) U.S. Cl. CPC G06Q 10/0635; G06F 21/6254; G06T 11/60; G06V 20/52; G06V 40/10; H04N 5/272

(57) ABSTRACT

The present invention relates to safety risk detection systems and methods and in particular to identifying possible hazards in working environments. The invention has been developed primarily for use in/with identifying safety risks and hazards in relatively high-risk workplaces such as construction sites and industrial sites and will be described hereinafter with reference to this application. The invention specifically relates to a method for anonymously detecting safety risk at a location, the method comprising the steps of: capturing digital images of the location; determining whether the captured digital images include individuals using a machine learning model; deidentifying individuals in the captured digital images to generate deidentified images; and identifying safety risks in the deidentified images using a safety machine learning model.

### CROSS-REFERENCE TO RELATED APPLICATIONS

This application is a 371 National Phase Entry of International Patent Application No. PCT/AU2023/050320 filed on Apr. 20, 2023, which claims the benefit of Australian Provisional Patent Application No. 2022901045 filed on Apr. 20, 2022, the contents of which are incorporated herein by reference in their entirety.

### FIELD OF THE INVENTION

The present invention relates to safety risk detection systems and methods and in particular to identifying possible hazards in working environments.

The invention has been developed primarily for use in/with identifying safety risks and hazards in relatively high-risk workplaces such as construction sites and industrial sites and will be described hereinafter with reference to this application. However, it will be appreciated that the invention is not limited to this particular field of use.

### BACKGROUND OF THE INVENTION

The adoption of camera equipment for use to identify safety risk on a worksite or generally in the workplace, is often met with resistance as employees may have concerns regarding their privacy being constantly monitored and the camera footage being used to prosecute employees rather than for improving worksite safety.

The relevant workplace privacy legislation and legal requirements for installing camera equipment may also change according to the location and type of workplace being monitored. This places an undue burden on the employer to keep abreast of privacy regulations in each of the areas where they are operating a worksite.

Existing camera systems further pose the risk that some employees may be discriminated against based on physical features captured by the camera equipment. For example, camera footage may be used to discriminate against people based on gender, ethnicity, physical appearance, and/or disability.

It can be seen that known prior art methods and systems for identifying safety risk has the problems of: (a) resistance to adoption based on privacy concerns; (b) concerns surrounding employee workplace persecution; (c) relevant privacy legislation may prevent installation; and (d) risk of discrimination based on identified physical characteristics.

The present invention seeks to provide an anonymous safety risk detection system and method which will overcome or substantially ameliorate at least one or more of the deficiencies of the prior art or to at least provide an alternative.

It is to be understood that, if any prior art information is referred to herein, such reference does not constitute an admission that the information forms part of the common general knowledge in the art in Australia or any other country.

### SUMMARY OF THE INVENTION

According to a first aspect of the present invention, there is provided a method for anonymously detecting safety risk at a location, comprising the steps of: capturing digital images of the location; determining, using a machine learning model, whether the captured digital images include individuals; deidentifying individuals in the captured digital images to generate deidentified images; and identifying, using a safety machine learning model, safety risks in the deidentified images.

It can be seen that the invention of the method for anonymously detecting safety risk at a location provides the benefit of determining hazardous conditions without impinging on the worker's privacy.

The method may further comprise the step of discarding the digital images after generating the deidentified images.

The step of deidentifying the individuals may comprise digitally masking the individual by superimposing a masked profile over the identified individual. Identifying safety risks may comprise analyzing the masked profile to identify safety risk. The term “masking” as used herein should be understood to encompass the use of any computer vision-based privacy preservation model that is configured to output one or more different visualizations with an intent to preserve the identity of any individual including, but not limited to, a mask, a mesh, and/or a 3-dimensional overlay superimposed upon at least a part of an image.

The step of deidentifying individuals may comprise identifying personal protective equipment worn by the individual and configuring the deidentification such that the personal protective equipment remains visible in the deidentified image.

One or more of the steps of: determining whether the digital images include individuals; deidentifying individuals in the digital images; and identifying safety risks in the masked images is performed locally and/or remotely.

According to a second aspect of the invention there is provided, a system for anonymously detecting safety risks at a location, comprising: a camera for capturing digital images of the location; and one or more processing devices and one or more storage devices storing instructions that, when executed causes the one or more processing devices to: determining, using a machine learning model, whether the captured digital images include individuals; deidentifying individuals in the captured digital images to generate deidentified images; and identify, using a safety machine learning model, safety risks in the deidentified images.

The digital images may be deleted or discarded after generating the deidentified images.

Deidentifying the individuals may comprise digitally masking the individual by superimposing a masked profile over the individual. Identifying safety risks may comprise analyzing the masked profile to identify safety risk.

Deidentifying individuals may comprise identifying personal protective equipment worn by the individual and configuring the deidentification such that the personal protective equipment remains visible in the deidentified image.

One or more of: determining whether the digital images include individuals; deidentifying individuals to generate deidentified images; and identifying safety risks in the deidentified images may be performed locally at the location and/or remotely.

Other aspects of the invention are also disclosed.

### BRIEF DESCRIPTION OF THE FIGURES

Notwithstanding any other forms which may fall within the scope of the present invention, a preferred embodiment of the invention will now be described, by way of example only, with reference to the accompanying drawings in which:

FIG. 1 is a block flow diagram of a method for anonymously detecting safety in accordance with a preferred embodiment of the present invention;

FIG. 2 is a system architecture and data flow diagram of a system for performing the method of FIG. 1; and

FIG. 3 is a visual representation of the step of preprocessing an image in accordance with preferred embodiments of the present invention.

### DETAILED DESCRIPTION OF THE PREFERRED EMBODIMENTS

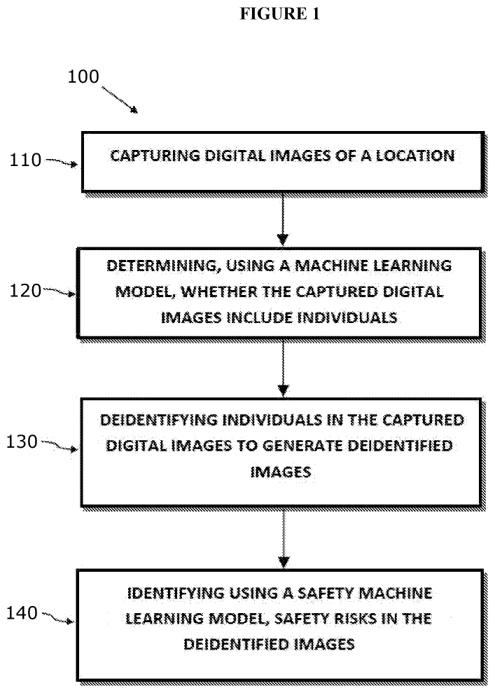

Referring to FIG. 1, a method (100) for anonymously detecting safety risk at a location according to an embodiment of the invention starts at step (110) by capturing digital images of the location. Images are typically captured by a digital camara or camera equipment.

Next, at step (120) a machine learning model is used to determine whether the captured digital images include individuals or people.

At step (130) any individual detected in the digital images are deidentified to generate deidentified images. It will be appreciated that these deidentified images do not contain any personal identification information.

Next, at step (140) using a safety machine learning model, the deidentified images are analyzed to identify safety risks.

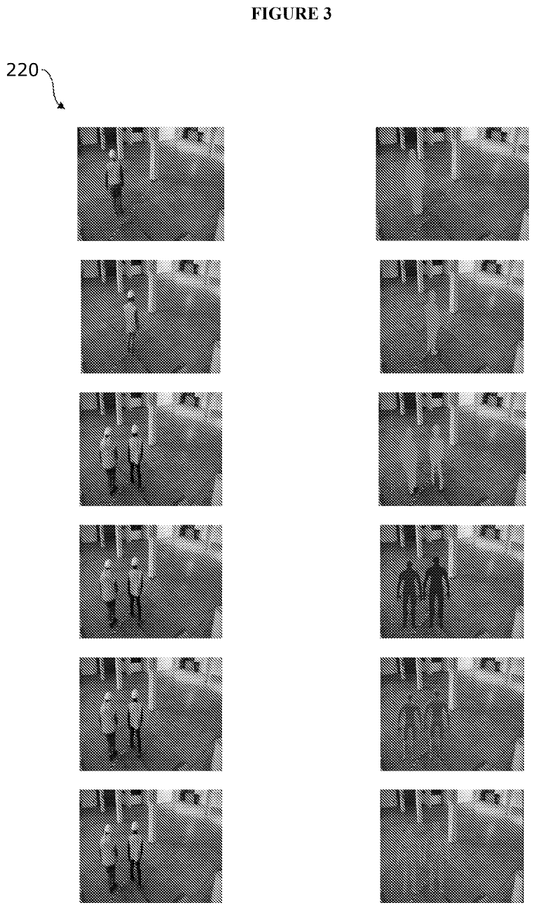

Importantly, the digital images that include personal identification information are not stored and are discarded after generating the deidentified images. Deidentifying the digital images may comprise digitally masking the individuals by superimposing a masked profile over the individual in the digital image. As shown for example in FIG. 3, the mask may cover the profile of an individual to remove any identifying physical characteristics.

Identifying safety risks (140) may comprise analyzing the masked profile to identify safety risk. For example, while the masked profile may remove any identifying characteristics of the individual, the position, movement, and orientation of the profile may still be analyzed to determine whether the individual is at risk of or has suffered an injury, for instance, a fall.

Deidentifying individuals may comprise first identifying personal protective equipment worn by the individual and configuring the deidentification, for instance the digital mask, such that the personal protective equipment remains visible in the deidentified image while still covering any identifying physical characteristics. This may be helpful in determine whether an individual is complying with all safety requirements, such as wearing a helmet, but without identifying the individual specifically.

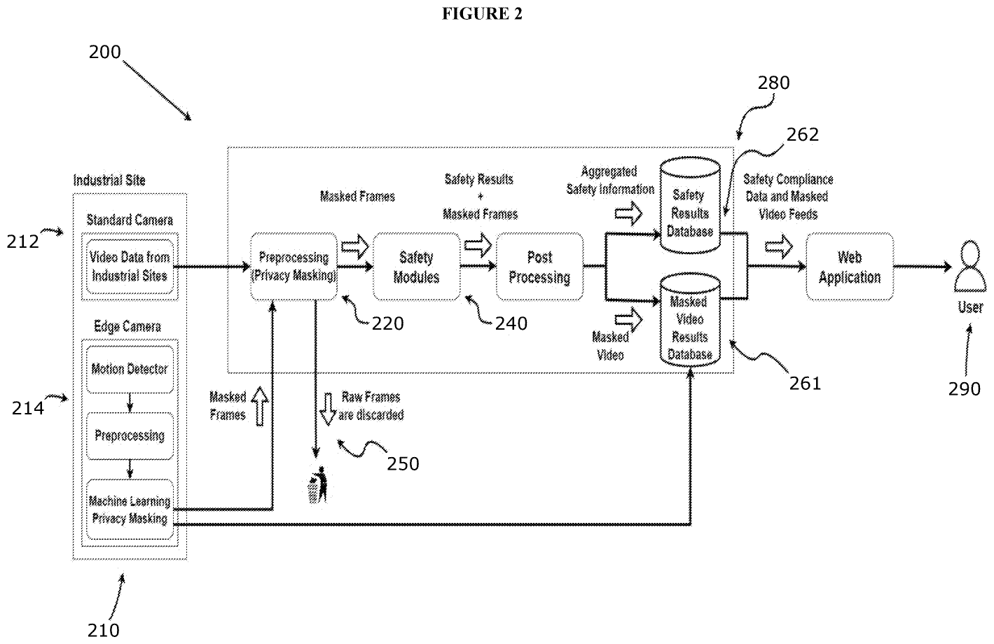

Referring to FIG. 2, a system for anonymously detecting safety risks at a location (200) is shown. The system (200) comprises one or more cameras (210) for capturing digital images of the location. The camaras may be a standard camara (212) configured to upload video data of the location to a remote computing service (280). Alternatively, the camara may be an edge camera (214) capable of performing image processing and image analysis locally.

The system comprises one or more processing devices and one or more storage devices storing instructions that, when executed, cause the one or more processing devices to perform the steps of the method described above. The processor can be arranged locally to perform the image processing and analysis on site. Alternatively, the processor may take the form of remote computing services such as cloud computing.

The local and/or remote processor is configured to determine, using a machine learning model, the presence of individuals and people in the digital images and deidentify the individuals to generate deidentified images. FIG. 3 illustrates the process of determining the presence of individuals in the digital images and deidentifying the images by, for instance, masking the individual's appearance with a masked profile to remove individual identifying characteristics.

For the example shown, at (250) the captured images with identifying personal information are deleted and discarded. As a result, no individual identifying information in relation to the captured digital images are retained.

The processor is further configured to identify, using a safety machine learning model, safety risks (240) in the masked images. Importantly, the masked profiles may be analyzed for movement and orientation to determine whether the masked individual's safety is at risk or is experiencing an emergency. For example, the masked profile may be monitored and analyzed to determine if the masked individual has experienced a fall.

Information relating to identified safety hazards is stored at (262) separate from the masked images that is stored at (261). Only the masked footage is stored made available for streaming to a user (290).

It can be seen that the system is advantageous for improving worksite safety, while encouraging adoption by ensuring individual anonymity.

### Interpretation

### Embodiments

Reference throughout this specification to “one embodiment” or “an embodiment” means that a particular feature, structure, or characteristic described in connection with the embodiment is included in at least one embodiment of the present invention. Thus, appearances of the phrases “in one embodiment” or “in an embodiment” in various places throughout this specification are not necessarily all referring to the same embodiment but may. Furthermore, the particular features, structures, or characteristics may be combined in any suitable manner, as would be apparent to one of ordinary skill in the art from this disclosure in one or more embodiments.

Similarly, it should be appreciated that in the above description of example embodiments of the invention, various features of the invention are sometimes grouped together in a single embodiment, figure, or description thereof for the purpose of streamlining the disclosure and aiding in the understanding of one or more of the various inventive aspects. This method of disclosure, however, is not to be interpreted as reflecting an intention that the claimed invention requires more features than are expressly recited in each claim. Rather, as the following claims reflect, inventive aspects lie in less than all features of a single foregoing disclosed embodiment. Thus, the claims following the Detailed Description of the Preferred Embodiments are hereby expressly incorporated into this Detailed Description of the Preferred Embodiments, with each claim standing on its own as a separate embodiment of this invention.

Furthermore, while some embodiments described herein include some, but not other features included in other embodiments, combinations of features of different embodiments are meant to be within the scope of the invention and form different embodiments, as would be understood by those in the art. For example, in the following claims, any of the claimed embodiments can be used in any combination.

### Different Instances of Objects

As used herein, unless otherwise specified the use of the ordinal adjectives “first,” “second,” “third,” etc., to describe a common object, merely indicate that different instances of like objects are being referred to and are not intended to imply that the objects so described must be in a given sequence, either temporally, spatially, in ranking, or in any other manner.

### Specific Details

In the description provided herein, numerous specific details are set forth. However, it is understood that embodiments of the invention may be practiced without these specific details. In other instances, well-known methods, structures, and techniques have not been shown in detail in order not to obscure an understanding of this description.

### Terminology

In describing the preferred embodiment of the invention illustrated in the drawings, specific terminology will be resorted to for the sake of clarity. However, the invention is not intended to be limited to the specific terms so selected, and it is to be understood that each specific term includes all technical equivalents which operate in a similar manner to accomplish a similar technical purpose. Terms such as “forward,” “rearward,” “radially,” “peripherally,” “upwardly,” “downwardly,” and the like are used as words of convenience to provide reference points and are not to be construed as limiting terms.

### Comprising and Including

In the claims which follow and in the preceding description of the invention, except where the context requires otherwise due to express language or necessary implication, the word “comprise” or variations such as “comprises” or “comprising” are used in an inclusive sense, i.e., to specify the presence of the stated features but not to preclude the presence or addition of further features in various embodiments of the invention.

Any one of the terms “including” or “which includes” or “that includes” as used herein is also an open term that also means including at least the elements/features that follow the term, but not excluding others. Thus, including is synonymous with and means comprising.

### Scope of Invention

Thus, while there has been described what are believed to be the preferred embodiments of the invention, those skilled in the art will recognize that other and further modifications may be made thereto without departing from the spirit of the invention, and it is intended to claim all such changes and modifications as fall within the scope of the invention. For example, any formulae given above are merely representative of procedures that may be used. Functionality may be added or deleted from the block diagrams and operations may be interchanged among functional blocks. Steps may be added or deleted to methods described within the scope of the present invention.

Although the invention has been described with reference to specific examples, it will be appreciated by those skilled in the art that the invention may be embodied in many other forms.

### Industrial Applicability

It is apparent from the above, that the arrangements described are applicable to the worksite safety industries.

What is claimed is:

1. A method for anonymously detecting safety risk at a location, the method comprising the steps of:
capturing digital images of the location;
determining, using a machine learning model, whether the captured digital images include individuals;
deidentifying individuals in the captured digital images to generate deidentified images; and
identifying, using a safety machine learning model, safety risks in the deidentified images.

2. The method of claim 1 further comprising the step of discarding the digital images after generating the deidentified images.

3. The method of claim 1 wherein the step of deidentifying the individuals comprises digitally masking the individual by superimposing a masked profile over the individual to create a masked image.

4. The method of claim 3 wherein the step of identifying safety risks comprises analyzing the masked profile to identify safety risk.

5. The method of claim 1 wherein the step of deidentifying individuals comprises identifying personal protective equipment worn by the individual and configuring the deidentification such that the personal protective equipment remains visible in the deidentified images.

6. The method of claim 3 wherein one or more of the steps of:
determining whether the digital images include individuals;
deidentifying individuals in the digital images; and
identifying safety risks in the masked images;
is performed locally.

7. The method of claim 1 wherein one or more of the steps of:
determining whether the digital images include individuals;
deidentifying individuals in the digital images;
identifying safety risks in the deidentified images;
is performed remotely.

8. A system for anonymously detecting safety risks at a location, the system comprising:
a camera for capturing digital images of the location; and
one or more processing devices and one or more storage devices storing instructions that, when executed causes the one or more processing devices to:
determining, using a machine learning model, whether the captured digital images include individuals;
deidentifying individuals in the captured digital images to generate deidentified images; and
identify, using a safety machine learning model, safety risks in the deidentified images.

9. The system of claim 8 wherein the digital images are deleted after generating the deidentified images.

10. The system of claim 8 wherein deidentifying individuals comprises digitally masking the individual by superimposing a masked profile over the individual.

11. The system of claim 10 wherein identifying safety risks comprises analyzing the masked profile to identify safety risk.

12. The system of claim 8 wherein deidentifying individuals comprises identifying personal protective equipment worn by the individual and configuring the deidentification such that the personal protective equipment remains visible in the deidentified images.

13. The system of claim 8 wherein one or more of:
determining whether the digital images include individuals;
deidentifying individuals to generate deidentified images; and
identifying safety risks in the deidentified images;
is performed locally at the location.

14. The system of any one of claim 8 wherein one or more of the steps of:
determining whether the digital images include individuals
deidentifying individuals to generate deidentified images; and
identifying safety risks in the deidentified images;
is performed remotely.

15. A method for anonymously detecting safety risk at a location, the method comprising the steps of:
a. capturing digital images of the location;
b. determining, using a machine learning model, whether the captured digital images include one or more individuals;
c. deidentifying the one or more individuals in the captured digital images to generate deidentified images;
d. discarding the digital images after generating the deidentified images; and
e. identifying, using a safety machine learning model, safety risks in the deidentified images;
wherein the step of deidentifying the individuals comprises:
i. digitally masking the individual by superimposing a masked profile over the individual to create a masked image;
ii. identifying personal protective equipment worn by the individual and configuring the deidentification such that the personal protective equipment remains visible in the deidentified images;
wherein the step of identifying safety risks comprises analyzing the masked profile to identify safety risk including:
i. using a safety machine learning model, for determining safety risks in the masked images;
ii. reviewing the masked profiles to be analyzed for movement, and orientation to determine whether the masked individual's safety is at risk or is experiencing an emergency or has experienced a nonsafety event such as a fall; and
iii. determine whether an individual is complying with all safety requirements required or determined at the location, such as wearing a helmet or harness but without identifying the individual specifically; and
f. wherein identifying safety risks in the masked images is performed locally or is performed remotely.
